(19) United States
(12) Patent Application Publication
(10) Pub. No.: US 2006/0151641 A1
(43) Pub. Date: Jul. 13, 2006

(54) Water jet aerator with three-part body and with optional shaped nozzle

(76) Inventor: H. Charles Li, Peachtree City, GA (US)

Correspondence Address: POWELL GOLDSTEIN LLP, ONE ATLANTIC CENTER, FOURTEENTH FLOOR 1201 WEST PEACHTREE STREET NW, ATLANTA, GA, 30309-3488, US

(21) Appl. No.: 11/320,383

(22) Filed: Dec. 28, 2005

Related U.S. Application Data
(60) Provisional application No. 60/640,346, filed on Dec. 30, 2004.

(51) Int. Cl. B05B 1/28; B05B 7/04; B05B 1/00; A62C 31/00

(52) U.S. Cl. 239/600; 239/290; 239/398

(57) ABSTRACT

A water jet aerator comprising a three part body that can be assembled on site so as to allow the installer to orient the water inlet port and the air inlet port in any orientation and an optional nozzle having a spout with at least four inwardly curved sides.

### STATEMENT OF RELATED APPLICATIONS

This patent application is based on and claims priority on U.S. provisional patent application No. 60/640,346 having a filing date of 30 Dec. 2004.

### BACKGROUND OF THE INVENTION

1. Technical Field

This invention relates generally to equipment for artificial water structures, such as pools, spas and hot tubs. More particularly, this invention relates to the body and nozzle structures of water jet aerators for use in these artificial water structures.

2. Prior Art

Water jet aerators can be used in artificial water structures, such as pools, spas and hot tubs, to provide jets of aerated water to provide a massaging and therapeutic action. The massaging and therapeutic action usually is provided by water jet aerators that are recessed into the walls of the artificial water structures. Several water jet aerators are usually spaced about the perimeter of an artificial water structure. In some water jet aerators, the nozzles may be rotated to achieve a desired flow. The nozzle is often a swivel type nozzle, which allows the direction of the flow to be adjusted by the user of the artificial water structure for maximum massaging or therapeutic action.

One type of water jet aerator that is in common use in artificial water structures uses the venturi process. The venturi process involves mixing a stream of pressurized water with ambient air. This venturi type action occurs in an aeration chamber, with the air being drawn into a low pressure chamber from a passageway that is connected to the ambient atmosphere. The low pressure is created by the flow of water through the low-pressure chamber. The mixture of pressurized water and air thereby provides an aerated jet of water, which then is discharged through a nozzle into the water contained in the artificial water structure.

These adjustable venturi-type water jet aerators may include a flow control system for manually adjusting the flow of air or water, or a combination of the air and water. For example, a first type of control system for a water jet aerator operates by manipulating the water flow and maintaining a steady, constant air flow through the aerator. A second type of control system adjusts both the air flow and the water flow simultaneously and proportionally. A third type of flow control system allows for independent adjustment of both the airflow and the water flow.

For the most part, water jet aerators are manufactured with a sealed single part body into which different nozzles can be inserted. The single part body is mounted on the spa in an orientation selected by the installer, or at random if the installer has no desired or instructed orientation. As the water inlet port and the air inlet port on the sealed single body cannot be moved or changed, the water inlet port and the air inlet port are oriented based on the installed orientation of the water jet aerator. If this orientation is inconvenient, it is difficult if not impossible to change, and this orientation may prove difficult or inconvenient for attaching the water and air lines.

Accordingly, there is always a need for an improved water jet aerator system. For example, there is a need for a water jet aerator having and adjustable water inlet port and/or an adjustable air inlet port. For another example, there is a need for a water jet aerator that is capable of being able to create a distinct pattern of water flow. Further, there is always a need for a water jet aerator with improved aeration and/or improved aesthetics. It is to these needs, among others, that the present invention is directed.

### BRIEF SUMMARY OF THE INVENTION

Briefly, this invention is an improved water jet aerator having a three-part body that can be assembled on site so as to allow the installer to orient the water inlet port and the air inlet port in any desired, necessary or convenient orientation. The three body parts are a water conduit, an air conduit, and an anchor sleeve, which are assembled together generally axially. Specifically, even though the anchor sleeve is secured to the spa body, the air conduit and the water conduit can be attached to each other and to the anchor sleeve with the water inlet port and the air inlet port oriented as desired. This is an important improvement over the prior art, in which the water conduit, the air conduit and the anchor sleeve are a sealed single unit with unchangeable water inlet port and air inlet port orientations.

The water jet aerator of the present invention, like many water jet aerators, comprises a nozzle, a face cover, a resilient grommet, an aeration chamber, an anchor sleeve, an air conduit, and a water conduit. The aeration chamber creates an aerated water stream by the mixing of air and water, which have been introduced into the aeration chamber via an air port and a water port aligned with the aeration chamber. The aerated water stream then flows through the nozzle into the artificial water structure (for ease of this disclosure, all artificial water structures such as but not limited to spas, hot tubs, JACUZZI®, pools, fountains, ponds, and whirlpools will be referred to herein as a “spa” or “spas”). Preferably, the nozzle does not extend into the spa beyond the face cover and is accessible from the spa, namely from the front side of the aerator. The nozzle has a fluid passage, which is in fluid communication with both the aeration chamber and the spa, to introduce aerated water into the spa.

This invention also is an improved water jet aerator utilizing the three-part body design in conjunction with a nozzle design potentially having improved aeration and/or a more aesthetically pleasing flow pattern. The potentially improved aeration can have a positive affect on the massage and/or therapeutic action of the aerated water jet emanating from the water jet aerator and the more aesthetically pleasing flow pattern can nave a positive affect on the visual aspects of the artifice water structure. The potentially improved aeration and aesthetically pleasing flow pattern are created by a nozzle configuration having a generally “+” or “x” shape.

The nozzle comprises a base and a spout. The base can be a common eyeball base holding the nozzle in the water jet aerator and allowing the nozzle to be directionally pivoted. The spout, however, has a shape and structure comprising a generally parallelogram-like arrangement with four inwardly curved sides, giving the nozzle a somewhat “+” or “x” shaped appearance when viewed head on. The nozzle preferably is attached to the aeration chamber so that adjustments to the nozzle can produce changes in the flow of the aerated water stream through the water jet aerator such as, for example by swiveling the nozzle so that the direction of flow into the spa can be varied according to the final direction of the nozzle. The nozzle, particularly the spout, may result in an aerated water stream potentially with improved aeration. Further, some people may find that the aerated water stream emanating from the nozzle, that is the pattern of bubbles through the preferred “+” or “x” shaped outlet in the nozzle, is aesthetically appealing.

The water flow to the aeration chamber preferably may be shut off by rotating the face cover, which thereby rotates the nozzle core assembly such that the core assembly opening rotates away from and therefore closes the water inlet port. The flow volume of water preferably also can be proportionally reduced by only partially rotating the face cover to a position where only a portion of the water core assembly opening is open, thus reducing the cross-sectional area of the water inlet port.

In operation and use, aerated water flows from the aeration chamber through the nozzle. The aerated water stream is discharged through the shaped nozzles, such as the “+” or “x” shaped nozzle outlet, resulting in the potentially increased aeration and aesthetics. In a typical installation, several water jet aerators are installed around the perimeter of a spa so to form a circuit of aerators.

These features, and other features and advantages of the present invention, will become more apparent to those of ordinary skill in the relevant art when the following detailed description of the preferred embodiments is read in conjunction with the appended drawings in which like reference numerals represent like components throughout the several views.

### BRIEF DESCRIPTION OF THE DRAWINGS

FIG. 1 is an exploded perspective side view of one embodiment of the water jet aerator of the present invention.

FIG. 2 is a front view of the nozzle shown in the water jet aerator in FIG. 1 with the preferred “+” or “x” shaped nozzle outlet.

FIG. 3 is a perspective view of the nozzle shown in FIG. 2.

FIG. 4 is a side view of an assembled water jet aerator.

FIG. 5 is a sectional side view of the three-part body of the present invention as shown in FIG. 4.

### DETAILED DESCRIPTION OF THE PREFERRED EMBODIMENTS

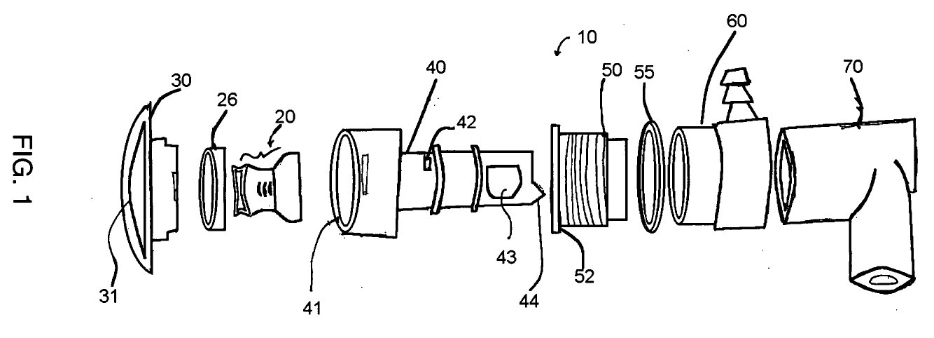

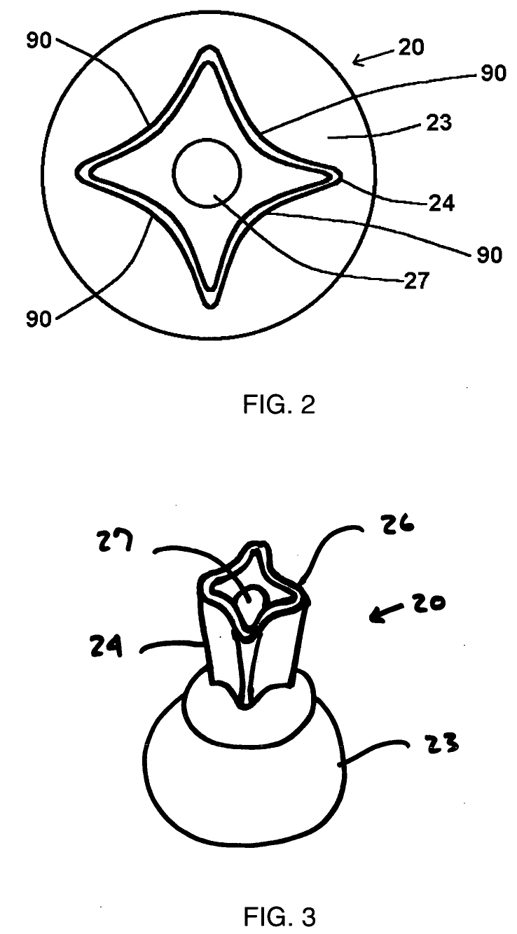

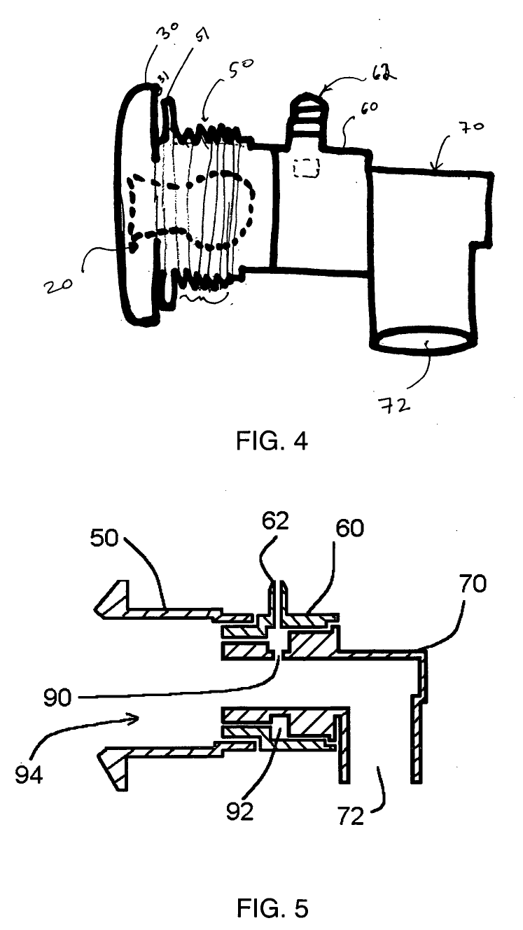

Illustrative embodiments of the best mode of the present invention include a water jet aerator that may be installed into the walls of an artificial water structures, collectively termed spas herein. Referring to the illustrative figures, FIG. 1 is an exploded perspective side view of one embodiment of the water jet aerator of the present invention showing the various structural components. FIG. 2 is a front view of the nozzle shown in the water jet aerator in FIG. 1 showing the preferred “+” or “x” shaped nozzle outlet. FIG. 3 is a perspective view of the nozzle shown in FIG. 2. FIG. 4 is a side view of an assembled water jet aerator as it would be attached to a spa. FIG. 5 is a sectional side view of the three-part body of the present invention in the assembled water jet aerator as shown in FIG. 4, but showing only the three main parts of the body. While the invention is described herein in conjunction with the preferred and illustrative embodiments, it will be understood that the invention is not limited to these embodiments.

1. General Water Jet Configuration.

Referring now to FIG. 1, a preferred embodiment of the water jet aerator 10 of the present invention comprises a nozzle 20, a face cover 30, an aeration chamber 40, an anchor sleeve 50, an air conduit 60, and a water conduit 70. When the components are assembled (see FIG. 4), the face cover 30 is located on the front of the water jet aerator 10 (within the spa tub) and the water inlet chamber is on the back of the water jet aerator 10 (outside of the spa tub). Preferably, the nozzle 20 is received into an opening 31 of the front cover 30 and secured within a nozzle casing 41 of the aeration chamber 40 at least in part by a resilient grommet 26. The nozzle 20 is accessible from the front of the water jet aerator so to allow for the nozzle 20 to be manually adjusted to control the direction of the water flow.

Referring now to FIGS. 2 and 3, the nozzle 20 comprises a base 23 and a spout 24. The base 23 preferably comprises a ball-like shape designed to fit in a socket such that it is capable of rotational movement within the nozzle casing 41. Preferably, the nozzle 20 has a swiveling, eyeball-type mechanism to direct the flow into the spa tub, which may be swiveled to adjust the water flow. As can be seen, there is an opening 27 in base 23 for passage of water therethrough.

Referring now to FIGS. 1 and 4, the nozzle 20, the face cover 30, the resilient grommet 26, the aeration chamber 40, the anchor sleeve 50, the air conduit 60, and the water conduit 70 may be assembled together so as to form a single unit. The nozzle 20 is coupled with the grommet 22, which then fits into the opening 31 of the front cover 30 and the nozzle casing 42 of the aeration chamber 40. Preferably, the grommet 26, which has a radius larger than the opening 31 of the face cover 30, is sized to snugly receive the base 23 of the nozzle and to prevent the nozzle 20 from dislodging through the face cover 30.

Generally speaking, the water conduit comprises the water inlet port and an outlet to the air conduit, the air conduit comprises the air inlet port and an outlet to the anchor sleeve, and the anchor sleeve comprises means for anchoring a nozzle. Further, the air conduit fits over the water outlet of the water conduit and the anchor sleeve fits over at least a portion of the air conduit. Thus, once the nozzle 20 is placed into the nozzle casing 41, the anchor sleeve 50 may slide over aeration chamber 40 such that the top edge 51 of the anchor sleeve 50 flanks the back edge 31 of the front cover 30. After the anchor sleeve 50 is secured, the nozzle 20 is secured within the aeration chamber 40. At this point, the anchor sleeve 50 may be threaded into an opening within the perimeter of a spa (not shown).

The air conduit 60 and the water conduit 70 are subsequently attached to the aeration chamber 40. Preferably, the air conduit 60 and the water conduit 70 are joined to the aeration chamber 40 such that both air and water may enter the aeration chamber 40. The conduits 60 and 70 are respectively connected to air and water supply lines (not shown) by the air inlet 62 and the water inlet 72, respectively. The water conduit 70 feeds into the air conduit 60 and then the water and air feed into the aeration chamber 40 for mixing and eventual introduction into the spa.

The water flow to aeration chamber 40 may be shut off by rotating the face cover 30, which thereby rotates the core assembly opening 43 of the aeration chamber 40. More particularly, the flow of water is cut off through the aerator 10 as the water inlet 71 is no longer aligned with the core assembly opening 43 of the aeration chamber 40. The flow of water also can be proportionally reduced by rotating the water opening 43 to a position where only a portion of the water opening 43 is overlapping the water inlet 32, thus reducing the cross-sectional area of water flow to the aeration chamber 40.

In a typical installation, several water jet aerators 10 are installed in the side walls of a spa so to form a circuit of aerators. The air conduit 60 of each the water jet aerators 10 can be joined to a common air manifold (not shown) and the water conduit 70 of each water jet aerator 10 can be joined to a common water manifold. The air manifold can be vented to the atmosphere at a level above water level in the spa, or can be coupled to the outlet of a blower (not shown). Likewise, the water conduits 30 can be coupled to a water manifold, which is supplied with pressurized water from a water pump. In this arrangement, an aerated water stream may be evenly spread throughout the spa structure.

In operation and use, aerated water flows from the aeration chamber through the nozzle 20. More particularly, water and air mix within the aeration chamber 40 and the now aerated water exits through the nozzle 20. The aerated water stream is discharged through the nozzle 20 into the spa tub.

2. Three-Part Body.

Referring now to FIGS. 4 and 5, the water jet aerator 10 has a three-part body 50, 60, 70 that can be assembled on site so as to allow the installer to orient the water inlet port 72 and the air inlet port 62 in any desired, necessary or convenient orientation. The three body parts are a water conduit 70, an air conduit 60, and an anchor sleeve 50, which are assembled together generally axially. Specifically, even though the anchor sleeve 50 is secured to the spa body, the air conduit 60 and the water conduit 70 can be attached to each other and to the anchor sleeve 50 with the water inlet port 72 and the air inlet port 62 oriented as desired.

This is an important improvement over the prior art, in which the water conduit, the air conduit and the anchor sleeve are a sealed single unit with unchangeable water inlet port and air inlet port orientations. The three-part body of the present invention allows for ease of installation in that the installer is not limited to installing a sealed single-orientation unit in the spa sidewall, but can more easily install the three body parts 50, 60, 70, onto the spa sidewall and then orient the three body parts 50, 60, 70 as necessary or desired.

Although the three parts 50, 60, 70 can be assembled on site in any order, for ease of description an illustrative order is disclosed below. However, the invention is not limited to his order, and the installer can choose an assembly order to suit the installer's needs or tastes.

Anchor sleeve 50 is installed through a previously cut hole in the side of the spa and is anchored or fastened to the sidewall of the spa using nut 55. Anchor sleeve 50 and nut 55 have cooperating screw threads so as to securely, yet preferably releasably, fasten anchor sleeve 50 to the spa sidewall. Rim 52 is located inside of the spa tub (the wet side) and generally contacts the spa sidewall, with the bulk of anchor sleeve 50 extending outside the spa tub (the dry side). Nut 55 is outside of the spa tub (the dry side).

Air conduit 60 and water conduit 70 are connected together and rotated relative to each other such that air inlet port 62 and water inlet port 72 are oriented relative to each other in a desired or necessary orientation. Generally, this orientation is dependent on the location of the air supply hose (not shown) and the water supply hose (not shown). For example, after the installation of the spa, the air supply hose and/or the water supply hose may be located above, below, to the side of, or at another location relative to the location of each spa jet 10. Thus, air inlet port 62 and water inlet port 72 can be rotated, preferably independently, to positions most convenient for attaching to the air supply hose and the water supply hose, thus easing installation. In this regard, the terminology most convenient preferably includes having the air inlet port oriented closest to the outlet end of the air supply hose or line and having the water inlet port oriented closest to the outlet end of the water supply hose or line. Air conduit 60 and water conduit 70 can be glued or otherwise adhered together (a melt weld, for example) so as to be made into a single permanent structure. Alternatively, air conduit 60 and water conduit 70 can be structured and dimensioned so as to have a snug fit and can remain as separate pieces releasably and rotationally connected to each other. The use of O-rings or other gaskets can help accomplish this.

Water conduit 70 has an annulus 92 formed therein that corresponds to the location of air inlet port 62 on air conduit 60. Annulus 92 allows air conduit 60 and water conduit 70 to be rotated relative to each other over 360° yet still allow air to flow through air inlet port 62 and then through aeration port 90 in water conduit 90 and into the aeration chamber 40 through separate aeration ports 42 in aeration chamber 40.

The combined air conduit 60 and water conduit 70 are attached to anchor sleeve 50 to form the three-part body. Air conduit 60 and water conduit 70 can be rotated relative to anchor sleeve 50 such that air inlet port 62 and water inlet port 72 are oriented in a desired or necessary orientation. As mentioned previously, generally, this orientation is dependent on the location of the air supply hose (not shown) and the water supply hose (not shown). Air conduit 60 and water conduit 70 can be glued or otherwise adhered to anchor sleeve 50 (a melt weld, for example) so as to be made into a single permanent structure. Alternatively, air conduit 60 and water conduit 70 can be structured and dimensioned so as to have a snug fit with anchor sleeve 50 and thus all three body parts 50, 60, 70 can remain as separate pieces releasably and rotationally connected to each other. The use of O-rings or other gaskets can help accomplish this. Typically, air conduit 60 has a throat that can be slid into a corresponding neck of anchor sleeve.

The nozzle 20 assembly, which has been inserted into the aerator chamber 40 assembly, and aerator chamber 40 assembly are inserted into the three-part body from the spa tub side (the wet side) through an open end of the anchor sleeve 50. Aerator chamber 40 assembly can be structured and dimensioned so as to have a snug yet rotatable fit with anchor sleeve 50, air conduit 60 and/or water conduit 70. The use of O-rings or other gaskets can help accomplish this. The structure and dimension of aerator chamber 40 assembly, by fitting snuggly within air conduit 60 and/or water conduit 70, and by cooperating with a ridge, rim or shoulder on anchor sleeve 50 and/or air conduit 60, also can assist in maintaining aerator chamber 40, anchor sleeve 50, air conduit 60 and water conduit 70 releasably and preferably rotatably connected.

As can be seen from the above disclosure and the appended figures, the three-part body allows for an infinite number of configurations of air inlet port 62 and water inlet port 72 relative to each other and relative to the air supply hose and the water supply hose. Such versatility provides a more convenient installation process.

3. Shaped Nozzle.

Referring back to FIGS. 2 and 3, the preferred “+” or “x” shape of nozzle 20, and thus the nozzle outlet through which the aerated water flows into the spa, potentially may create an improved aerated water stream. Improved aeration may increase the massage and/or therapeutic activity of the aerated water stream. Rather than allowing the aerated water to exit nozzle 20 into the spa tub in the common circular formation, the “+” or “x” shape of nozzle 20 potentially forces the aerated water to flow in a different formation. As a result, the “+” or “x” shape of nozzle 20 potentially may create a different flow of aerated water within the spa tub. This different flow formation may provide improved or different therapeutic or massage characteristics and/or improved or different aesthetics, both of which may increase the desirability of the nozzle of the present invention and/or any spa incorporating the nozzle of the present invention, thus increasing the value of any spa incorporating the nozzle of the present invention.

The above detailed description of the preferred embodiments, examples, and the appended figures are for illustrative purposes only and are not intended to limit the scope and spirit of the invention, and its equivalents, as defined by the appended claims. One skilled in the art will recognize that many variations can be made to the invention disclosed in this specification without departing from the scope and spirit of the invention.

What is claimed is:

1. A water jet aerator comprising:
a) a first body part having a water conduit and a water inlet port;
b) a second body part having an air conduit and an air inlet port; and
c) a third body part having an anchor sleeve,
whereby the first body part, the second body part and the third body part form a three-part body that can be assembled on site so as to allow the water inlet port and the air inlet port to be oriented in any orientation relative to each other and relative to the third body part.

2. The water jet aerator as claimed in claim 1, wherein the three body parts are assembled together generally axially.

3. The water jet aerator as claimed in claim 2, wherein the air conduit and the water conduit are attached to each other and to the anchor sleeve with the water inlet port and the air inlet port oriented as desired.

4. The water jet aerator as claimed in claim 3, wherein the water conduit comprises the water inlet port and an outlet to the anchor sleeve, the air conduit comprises the air inlet port and an outlet leading to the water conduit, and the anchor sleeve comprises means for anchoring a nozzle.

5. The water jet aerator as claimed in claim 4, wherein the water inlet port is oriented during installation of the water jet aerator to cooperate most efficiently with a water supply source, and the air inlet port is oriented during installation of the water jet aerator to cooperate most efficiently with an air supply source.

6. The water jet aerator as claimed in claim 5, wherein the water conduit further comprise an annulus formed therein that corresponds to the location of the air inlet port on the air conduit, whereby the annulus allows the air conduit and the water conduit to be rotated relative to each other over 360° and allow air to flow through the air inlet port into water conduit.

7. The water jet aerator as claimed in claim 6, further comprising an aeration port in the water conduit leading into an aeration chamber.

8. The water jet aerator as claimed in claim 7, wherein the anchor sleeve is secured to a spa, the air conduit and the water conduit are attached to each other and to the anchor sleeve with the water inlet port and the air inlet port oriented as desired.

9. The water jet aerator as claimed in claim 8, wherein the air conduit fits over the water outlet of the water conduit and the anchor sleeve fits over at least a portion of the air conduit.

10. The water jet aerator as claimed in claim 8, wherein the air conduit and the water conduit are rotatably connected to each other.

11. The water jet aerator as claimed in claim 8, wherein the air conduit and the water conduit are releasably connected to each other.

12. The water jet aerator as claimed in claim 8, wherein the air conduit and the water conduit are rotatably and releasably connected to each other.

13. The water jet aerator as claimed in claim 8, further comprising a nozzle having at least four inwardly curved sides forming an “+” or “x” configuration.

14. The water jet aerator as claimed in claim 13, having improved water aeration.

15. The water jet aerator as claimed in claim 13, having improved aerated water outflow aesthetics.

16. A water jet aerator comprising:
a) a first body part having a water conduit and a water inlet port;
b) a second body part having an air conduit and an air inlet port;
c) a third body part having an anchor sleeve; and
d) a nozzle having at least four inwardly curved sides forming an “+” or “x” configuration,
whereby the first body part, the second body part and the third body part form a three-part body that can be assembled on site so as to allow the water inlet port and the air inlet port to be oriented in any orientation relative to each other and relative to the third body part.

17. The water jet aerator as claimed in claim 16, wherein the three body parts are assembled together generally axially; the air conduit and the water conduit are attached to each other and to the anchor sleeve with the water inlet port and the air inlet port oriented as desired; and the water conduit comprises the water inlet port and an outlet to the anchor sleeve, the air conduit comprises the air inlet port and an outlet leading to the water conduit, and the anchor sleeve comprises means for anchoring a nozzle.

18. The water jet aerator as claimed in claim 17, wherein the water inlet port is oriented during installation of the water jet aerator to cooperate most efficiently with a water supply source, and the air inlet port is oriented during installation of the water jet aerator to cooperate most efficiently with an air supply source.

19. The water jet aerator as claimed in claim 18, wherein the water conduit further comprise an annulus formed therein that corresponds to the location of the air inlet port on the air conduit, whereby the annulus allows the air conduit and the water conduit to be rotated relative to each other over 360° and allow air to flow through the air inlet port into water conduit.

20. The water jet aerator as claimed in claim 19, wherein the anchor sleeve is secured to a spa, the air conduit and the water conduit are attached to each other and to the anchor sleeve with the water inlet port and the air inlet port oriented as desired.

21. The water jet aerator as claimed in claim 20, wherein the air conduit fits over the water outlet of the water conduit and the anchor sleeve fits over at least a portion of the air conduit.

22. The water jet aerator as claimed in claim 21, wherein the air conduit and the water conduit are rotatably connected to each other.

23. The water jet aerator as claimed in claim 21, wherein the air conduit and the water conduit are releasably connected to each other.

24. The water jet aerator as claimed in claim 21, wherein the air conduit and the water conduit are rotatably and releasably connected to each other.
